(19) United States
(12) Patent Application Publication
(10) Pub. No.: US 2016/0029298 A1
(43) Pub. Date: Jan. 28, 2016

(54) Method of Controlling WLAN Access for Wireless Communication Devices

(71) Applicant: TELEFONAKTIEBOLAGET L M ERICSSON (PUBL), Stockholm (SE)

(72) Inventors: Mattias Tan Bergström, Stockholm (SE); Filip Mestanov, Sollentuna (SE)

(21) Appl. No.: 14/427,260

(22) PCT Filed: Jan. 15, 2015
(86) PCT No.: PCT/SE2015/050031

§ 371 Date: Mar. 10, 2015

Related U.S. Application Data
(60) Provisional application No. 61/937,746, filed on Feb. 10, 2014.

(51) Int. Cl. H04W 48/16; H04W 48/08

(52) U.S. Cl. CPC H04W 48/16; H04W 48/08; H04W 84/12

(57) ABSTRACT

The present disclosure relates to method performed by a wireless communication device (2; 4) for controlling its access to one or several Wireless Local Area Networks (WLANs). The present disclosure also relates to a wireless communication device (2; 4) adapted and configured to perform the method. The method identifies a set of operators which are considered applicable to the wireless communication device (2; 4) and obtains an operator identity for each operator. The wireless communication device (2; 4) scans for available WLANs and in response to finding a WLAN, determines whether a found WLAN is applicable for the wireless communication device (2; 4). If the found WLAN is applicable the wireless communication device (2; 4) connects to the found WLAN.

### TECHNICAL FIELD

The present disclosure generally relates to wireless communication systems. More particularly, the disclosure relates to mobility of a wireless communication device between WLANs (Wireless Local Area Networks) and cellular communication networks, such as 3rd Generation Partnership Project (3GPP) cellular communication networks.

### BACKGROUND

It is currently discussed in 3GPP a solution in which the wireless communication device performs mobility between 3GPP and WLAN based on rules specified in 3GPP specification. The description for this solution is as follows (found in [3GPP TR 37.823 Study on WLAN/3GPP Radio Interworking v1.0.0]). Note that we herein are sometimes using the term “UE (User Equipment)”/“wireless communication device”/“STA (Station)” interchangeably.

Throughout this description, some terms for various network or parts of networks will be used;

“Cellular network”, or “3GPP network” will be used to denote a complete communication network, e.g. a communication network which comprises both a RAN (Radio Access Network) and a core network.

“Radio Access Network” (RAN) is the part of the cellular network which connects wireless communication devices, e.g. UEs. For instance, in UMTS (Universal Mobile Telecommunication System), the RAN comprises the NodeBs and RNCs (Radio Network Controllers), and in LTE (Long Term Evolution), the RAN comprises eNodeBs.

The “Solution 2” which will be described below relates to the 3GPP publication mentioned above. FIG. 6.1.2.1-1 of this 3GPP publication is included as FIG. 1 in the accompanying drawings. It is to be noted that the paragraph numbers 6.1.2 and 6.1.2.1 relate the 3GPP publication. Likewise, the reference “FIG. 6.1.2.1-1” relates to the 3GPP publication and not to the accompanying drawings of this application.

6.1.2 Solution 2

In this solution the offloading rules are specified in RAN specifications. The RAN provides (through dedicated and/or broadcast signaling) thresholds which are used in the rules.

This solution is applicable to UEs in RRC IDLE and RRC CONNECTED states for E-UTRAN, UE IDLE mode for UTRAN and CELL_FACH, CELL_PCH, URA_PCH and CELL_DCH states for UTRAN).

6.1.2.1 Description

This solution consists of the following steps, which is described in the following figure.

For the signaling procedure of FIG. 1, each step is elaborated below.

Step 1:

The RAN provides parameters through dedicated signaling and/or broadcast signaling.

Step 2:

The UE follows RAN rules, defined in 3GPP RAN specifications, to perform bi-directional offloading between WLAN and 3GPP. User preference should take precedence.

### Rule Example

if (measured_metricA < threshold1) && (measured_metricB >
threshold2) {

steerTrafficToWLAN( );

} else if (measured_metricA > threshold3) ∥ (measured_metricB <
threshold4) {

steerTrafficTo3gpp( );

}

In addition, if the UE has been configured with ANDSF rules, the ANDSF rules should not be broken, details are FFS.

It is FFS whether and how per bearer steering will be done, if ANDSF is not present. The inclusion of section 6.1.2 of the 3GPP publication ends here.

It has in 3GPP been discussed different mechanisms for provisioning WLAN identifiers from the network to the UE which indicates to the UE which WLANs should be considered in the WLAN interworking mechanism, i.e. the above described mechanism.

Another example mechanism is that the 3GPP network broadcasts a set of SSIDs (Service Set Identifier)/BSSIDs (Basic SSID)/HESSIDs (Homogeneous Extended SSID)/etc. The UE would then for the WLANs corresponding to the broadcasted identifier evaluate whether or not to connect to such a WLAN.

Different standards organizations have started to recognize the needs for an enhanced user experience for Wi-Fi access, this process being driven partly by 3GPP operators. An example of this is the Wi-Fi Alliance with the Hot-Spot 2.0 (HS2.0) initiative, now officially called Passpoint (“Hotspot 2.0 (Release 1) Technical Specification”, Wi-Fi Alliance® Technical Committee Hotspot 2.0 Technical Task Group, V 1.0.0). HS2.0 is primarily geared toward Wi-Fi networks. HS2.0 builds on IEEE 802.11u, and adds requirements on authentication mechanisms and auto-provisioning support.

The momentum of Hot-Spot 2.0 is due to its roaming support, its mandatory security requirements and for the level of control it provides over the wireless communication device for network discovery and selection. Even if the current release of HS2.0 is not geared toward 3GPP interworking, 3GPP operators are trying to introduce additional traffic steering capabilities, leveraging HS2.0 802.11u mechanisms. Because of the high interest of 3GPP operators, there will be a second release of HS2.0 focusing on 3GPP interworking requirements.

HS2.0 contains the following procedures:
1 Discovery: where the wireless communication device discovers the Wi-Fi network, and probes them for HS2.0 support, using 802.11u and HS 2.0 extensions.
2 Registration is performed by the wireless communication device toward the Wi-Fi Hot-spot network if there is no valid subscription for that network.
3 Provisioning: Policy related to the created account is pushed toward the wireless communication device. This only takes place when a registration takes place.
4 Access: cover the requirements and procedures to associate with a HS2.0 Wi-Fi network.

IEEE 802.11u-2011 is an amendment to the IEEE 802.11 family of protocols that introduces several improvements for internetworking between WLAN and external networks (e.g. 3GPP RAN). Some of the most interesting new features are the Generic Advertisement Service, the Access Network Query Protocol (ANQP) and Network Discovery and Selection information elements.

The Generic Advertisement Service (GAS) is an information exchange protocol between the STA and the AP (Access Point), which is used to carry Layer 2 frames in a pre-association state, enabling the STA to receive AP-related information even before the association has taken place. In that manner, the STA does not need to associate with the AP in order to receive information about the network identity and whether or not it is allowed to route traffic via that AP. Consequently, this feature increases the efficiency of the original IEEE 802.11 procedures by avoiding unnecessary association attempts. GAS frames carry (among others) ANQP messages.

The Access Network Query Protocol (ANQP) plays a major role in improving the network discovery capabilities in a WLAN. It enables STAs to receive network-related information, such as the Operator Friendly Name, Network Access Identifier (NAI) Realm and the Roaming Consortium to which the AP belongs to, 3GPP Cellular Network Information, Vendor Specific Information (used for the transfer of Hotspot™ 2.0-specified information elements) and many others. For the purpose of the current document, the 3GPP Cellular Network Information is of a particular interest for it carries information about the list of Public Land Mobile Networks (PLMNs) that the STA can access via this particular AP. The field's content is specified by Annex A of 3GPP TS 24.234. To better illustrate the information that the STA can obtain via ANQP signaling, we give some examples of the contents of the fields in the ANQP exchange:
3GPP Cellular Network Information
   24001 (Telia)
   24008 (Telenor)
Operator Friendly Name
   “Boingo”
NAI Realm
   “access.boingo.com”
Roaming Consortium
   001bc50050
   001bc500b5

With reference to FIG. 2 an exemplary ANQP exchange between the STA and a HS 2.0 enabled AP will be described. FIG. 2 schematically illustrates a WPA2 (Wi-Fi Protected Access)-Enterprise procedure with EAP (Extensible Authentication Protocol)-SIM (Subscriber Identity Module) for HotSpot™ 2.0

The procedure:
1 The STA receives a Beacon frame, broadcasted by the AP carrying indication that the AP is HotSpot™ 2.0-enabled. The format of the beacon frame is described in Chapter 8.3.3.2 of IEEE 802.11, where the “Vendor Specific” field is used to indicate the HotSpot™ 2.0 capabilities;
2 If the STA does not receive a Beacon frame for some reason, it can generate a Probe Request and send it to the AP. The Probe Request frame is described in Chapter 8.3.3.9 of IEEE 802.11, and the “Vendor Specific” field carries the indication that the STA is HotSpot™ 2.0-enabled;
3 The AP answers with a Probe Response (Chapter 8.3.3.10 of IEEE 802.11), also indicating that it is HotSpot™ 2.0-enabled;
4 After the STA has recognized that the AP is HotSpot™ 2.0-enabled, it knows that the AP has Generic Advertisement Service (GAS) capabilities. The STA then generates a GAS Initial Request in order to obtain information about an internetworking service;
5 The AP responds with GAS Initial Response. If the information requested by the STA cannot be fitted into one GAS frame and fragmentation is needed, the AP includes a GAS Query ID and GAS Comeback Delay information. The delay indicates the amount of time that the requesting STA should wait before another GAS Comeback frame exchange can be performed;
6 After the GAS Comeback Delay has expired, the STA sends a GAS Comeback Request (Chapter 8.5.8.14 in IEEE 802.11), requesting the rest of the information. The STA must use the same Query ID, as previously assigned by the AP;
7 The AP responds with GAS Comeback Response (Chapter 8.5.8.15 in IEEE 802.11). Once all the GAS Comeback Response frames have been received (the AP indicates the last fragment by setting the “More GAS Fragments” bit in the Fragment ID field in the GAS Comeback Response to “1”), the STA can defragment and process the information;
a. NOTE 1: In the “Advertisement Protocol Element” field, part of the GAS frame (described in Chapter 8.5.8.12 of IEEE 802.11), the STA can include an ANQP query Chapter 8.4.4 of IEEE 802.11). ANQP queries are used to obtain miscellaneous network information, including Network Access Identifier (NAI) Realm, 3GPP Cellular Network Information, etc;
b. NOTE 2: The AP might forward or proxy the ANQP queries to a backend advertisement server (possibly a 3GPP entity). If the ANQP query requests 3GPP Cellular Network Information, the payload will be a Generic Container (described in Annex A of 3GPP TS 24.234). According to the current standards, the only type of information carried is the list of PLMNs, that can be selected from the WLAN.

The current mechanisms for provisioning WLAN identifiers from the cellular network to the wireless communication device require signalling from the RAN (or possibly from the MME (Mobility Management Unit)) to the UE. Signaling of WLAN identifiers has at least the following problems:

Many of the WLAN identifier provisioning mechanisms result in quite a large impact on the network. Something which is also important is the requirement to configure the network. Many of the mechanisms require the RAN (or MME) to be aware of which WLANs (and their identifiers) are deployed where. For example, in the mechanism where the RAN broadcasts the WLAN identifiers it is necessary that the RAN is configured to be aware of which WLANs are within the coverage of the RAN node(s). This configuration may be required to be done manually by the operator which could result in high OPEX (Operating Expenditures) costs.

Power consumption—Signaling between the wireless communication device and the network will consume wireless communication device and network power. Wireless communication device power consumption is a problem which is particularly critical as the UEs are usually driven by batteries and hence increased wireless communication device power consumption will reduce the wireless communication device battery lifetime with a reduced user experience as a consequence.

In addition, many of the existing mechanisms require that the WLAN identifiers are signalled to the wireless communication device using radio resources. The signalling of these identifiers would of course increase the signalling overhead and degrade system performance.

Thus, there is a problem for operators of cellular communication networks to effectively offer increased mobility to end users and increase user experience.

### SUMMARY

It is in view of the above considerations and others that the various embodiments disclosed herein have been made.

In this invention the wireless communication device will determine what the PLMN is of a 3GPP network and consider WLANs which has this PLMN when doing mobility between 3GPP and WLAN.

In one of its aspects, the technology presented herein concerns a method performed by a wireless communication device for controlling its access to one or several Wireless Local Area Networks (WLANs), wherein the wireless communication device is associated with a cellular communication network of an operator or a partner of said operator. The method comprises identifying a set of operators which are considered applicable to the wireless communication device. Each operator of the set of operators is associated with one or more corresponding WLANs. Furthermore the wireless communication device obtains an operator identity for each operator of the set of operators and scanning for available WLANs. In response to finding a WLAN during the scanning the wireless communication device determines whether a found WLAN is applicable for the wireless communication device based on the operator identities of the set of operators. In response to that the found WLAN is determined applicable the wireless communication device connects to the found WLAN.

The method may further comprise implementing the operator identity as one of a set comprising: PLMN-ID (Public Land Mobile Network Identity), an operator friendly name, a NAI (Network Access Identifier) Realm, and a roaming consortium.

The method may further comprise determining whether a signal strength of the found WLAN is above a pre-defined threshold, and connecting to the found WLAN only if the signal strength is above the threshold.

Furthermore, obtaining the operator identity may comprise receiving the operator identity from a Radio Access Network (RAN) node of the cellular communication network or retrieving the operator identity from a Subscriber Identity Module (SIM) of the wireless communication device.

In another one of its aspects, the technology presented herein concerns a wireless communication device adapted to control the access of the wireless communication device to Wireless Local Area Networks (WLANs). The wireless communication device is associated with a cellular communication network of an operator or a partner of said operator. The wireless communication device comprises a controller adapted to identify a set of operators which are considered applicable to the wireless communication device for WLAN mobility, each operator of the set of operators being associated with at least one corresponding WLAN. The controller is further adapted to obtain an operator identity for each operator of the set of operators and determine a set of applicable WLANs, such as WLANs provided by the operator or the partner of the operator, based on the obtained operator identities. The wireless communication device further comprises a communication module adapted to scan for available WLANs. If a WLAN is found the controller is adapted to determine whether the found WLAN is applicable for the wireless communication device, based on the operator identities of the set of operators. The communication module is further adapted to connect the wireless communication device to the found WLAN in response to that the found WLAN is determined applicable.

The wireless communication device may further be adapted to recognize operator identities implemented as one of a set comprising: PLMN-ID (Public Land Mobile Network Identity), an operator friendly name, a NAI (Network Access Identifier) Realm, and a roaming consortium.

The controller of the wireless communication device may be further adapted to determine whether a signal strength of the found WLAN is above a pre-defined threshold, and the communication module (18) is further adapted to connect to the found WLAN only if the signal strength is above the threshold.

The communication module may further be adapted to receive the operator identity of each of the operators of the set of operators from a RAN node of the cellular communication network. The wireless communication device may also comprise a Subscriber Identity Module (SIM), from which the controller (14) is adapted to retrieve the operator identity of each of the operators.

Other more detailed mechanisms are also presented to address special scenarios and for improvement of performance. It is also to be noted that the disclosed concept is not limited to apply PLMN-IDs for determining considered applicable WLANs, any other suitable identifiers which are capable of defining considered applicable WLANs may alternatively be applied instead when appropriate.

### BRIEF DESCRIPTION OF DRAWINGS

The solution will now be described in more detail by means of exemplary embodiments and with reference to the accompanying drawings, in which:

FIG. 1 is a schematic signal chart of a scenario, in accordance with existing art.

FIG. 2 is a schematic signal chart of a scenario, in accordance with existing art.

FIG. 3 is a schematic flow chart of a method in a UE, according to possible embodiments.

FIG. 4 is another schematic flow chart of a method in a UE, according to possible embodiments.

FIG. 5 is a schematic overview of a scenario, according to possible embodiments.

FIG. 6 is a schematic block diagram of a UE, according to possible embodiments.

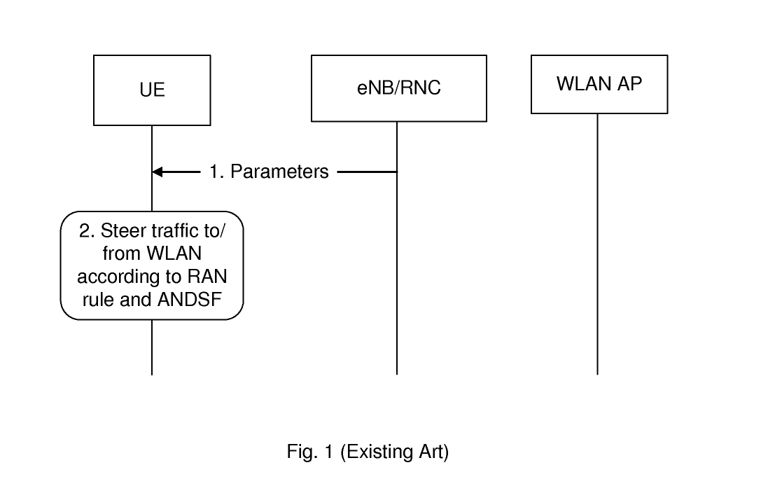

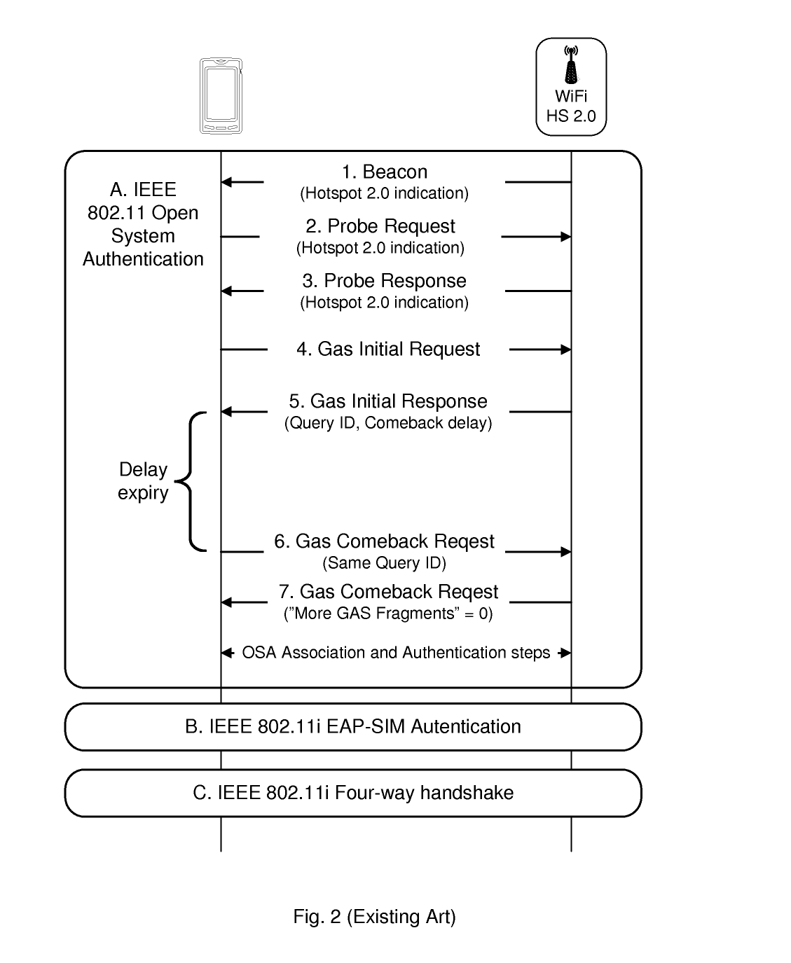

### DETAILED DESCRIPTION

The term “wireless communication device” will be used throughout this description to denote any device which is capable of wireless communications. The term wireless communication device may thus include any device, which may be used by a user for wireless communication. Accordingly, the term wireless communication device may alternatively be referred to as a mobile terminal, a terminal, a user terminal (UT), a user equipment (UE), a wireless terminal, a wireless communication device, a wireless transmit/receive unit (WTRU), a mobile phone, a cell phone, a table computer, a smart phone, etc. Yet further, the term wireless communication device includes MTC (Machine Type Communication) devices, which do not necessarily involve human interaction. MTC devices are sometimes referred to as Machine-to-Machine (M2M) devices.

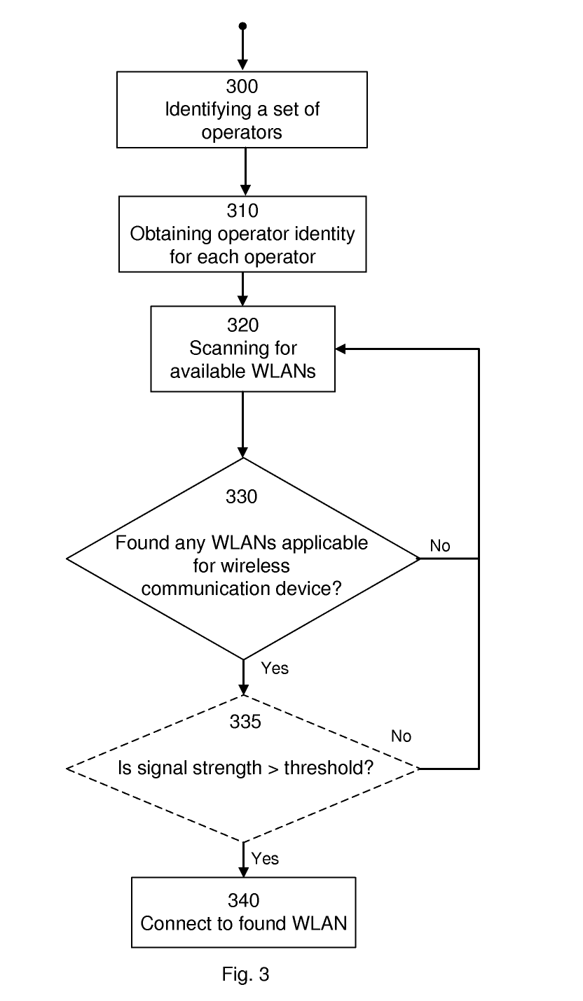

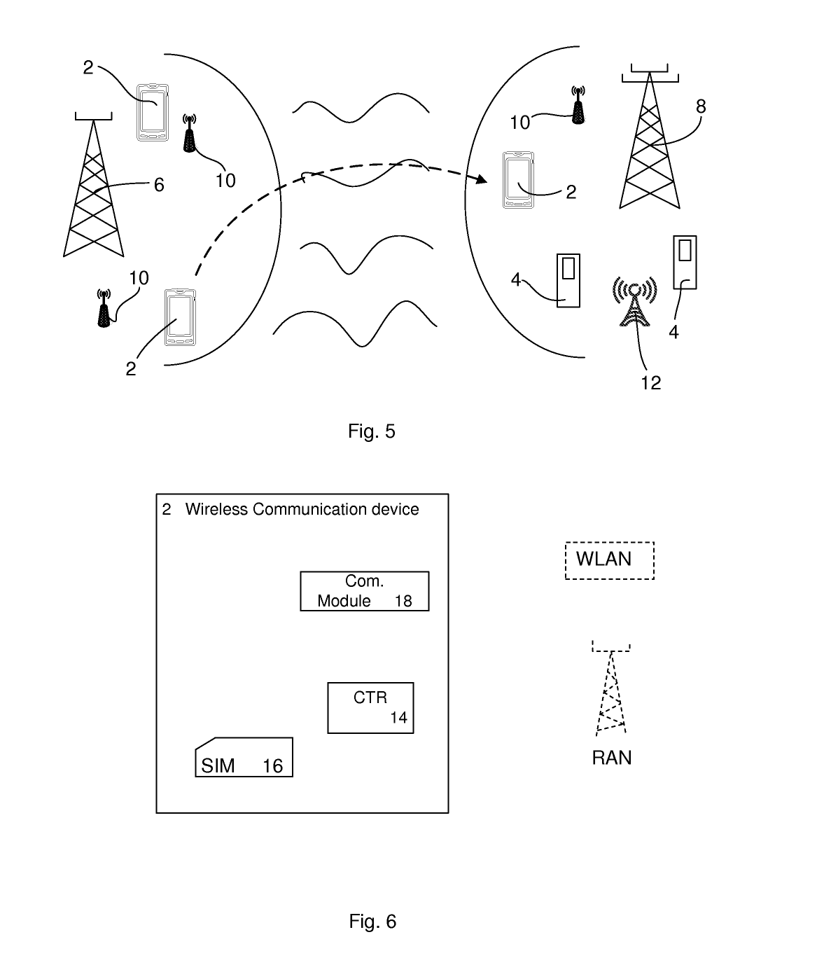

Turning now to FIG. 3, the method for controlling access to one or several WLANs according an exemplary embodiment will be described. As mentioned above the method is performed by a wireless communication device 2, 4, which is depicted in FIGS. 5 and 6 and which will be further described below. The wireless communication device 2, 4 is associated with a cellular communication network of an operator or a partner of said operator. The method starts in step 300 by identifying a set of operators which are considered applicable to the wireless communication device 2, 4, i.e. operators that the wireless communication device 2, 4 is able to use. Each operator of the set of operators is furthermore associated with one or more corresponding WLANs. In step 310 the method obtains an operator identity for each operator of the set of operators. In step 320 the wireless communication device 2, 4 is scanning for available WLANs within its range. In response to finding a WLAN during the scanning the wireless communication device determines, in step 330, whether a found WLAN is applicable for the wireless communication device 2, 4. The determination in step 330 is based on the operator identities of the set of operators. If no WLANs are found during scanning, the wireless communication device continues to scan regularly. If an applicable WLAN has been found the method, in step 340, connects the wireless communication device 2, 4 to the found WLAN.

In FIG. 3, there is also depicted an optional step 335. In this exemplary embodiment of the method a signal strength of the found applicable WLANs is measured. In this exemplary embodiment the connection of the wireless communication device is only connected to the applicable WLAN if the signal strength is above a predetermined threshold.

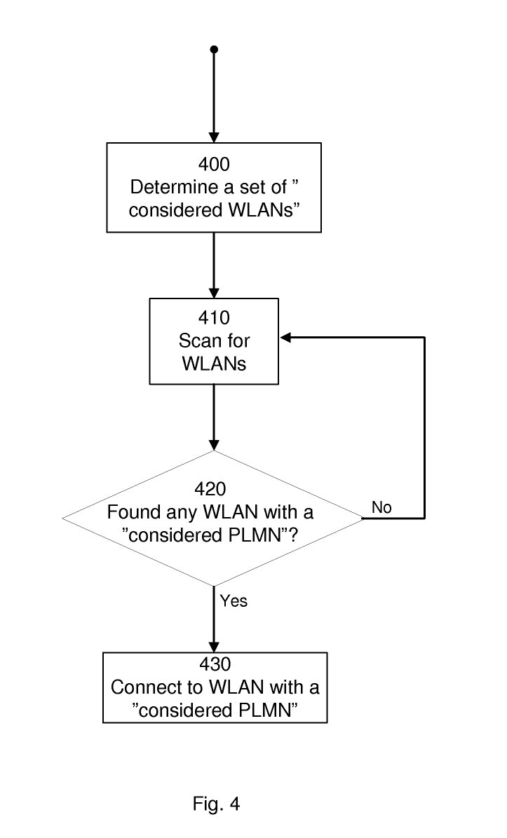

In one other embodiment, depicted in FIG. 4 the wireless communication device 2, 4 will determine a set of PLMNs, in step 400, which are considered applicable to the wireless communication device 2, 4 for WLAN mobility. These PLMNs will be referred to as the considered PLMNs. In many scenarios it will be so that there is only one considered PLMN however special cases exist, some of which are described below. Which the considered PLMNs are can be determined in different ways depending on the scenario which will be described below. For instance, considered applicable WLANs may be a PLMN of the users operator and PLMNs of the operator's roaming partners.

When the wireless communication device 2, 4 evaluates whether it should steer traffic to the WLAN it will only consider WLANs which are associated with the considered PLMNs. Which PLMN a WLAN is associated with can be determined by performing an ANQP exchange with the available HotSpot2.0 enabled APs.

According to one embodiment the considered PLMN is the PLMN of the 3GPP network which the wireless communication device, e.g. a UE or any other suitable terminal, is currently connected to. The wireless communication device may determine which PLMN the 3GPP network belong to by reading the broadcast channel in the 3GPP network.

In another embodiment the wireless communication device will consider PLMNs based on information on a SIM-card. The operator may then have been configuring the SIM-card of the wireless communication device to contain a list of PLMNs which should be considered. For example an Operator X may have configured the SIM-card of the wireless communication device to contain the PLMN of Operator X, but Operator X may also have configured other PLMNs on the SIM-card, e.g. the PLMN of a partner of the operator.

After determining a set of considered WLANs the wireless communication device 2, 4, in step 410 scans for WLANs, corresponding to step 320 in FIG. 3. In step 420 it is determined if any WLANs with a “considered PLMN” was found. If such a WLAN was found the wireless communication device is connected to the considered PLMN, in step 430.

It is to be noted some steps of the flow charts described above may comprise a plurality of actions. For instance, the step of determining a set of considered WLANs may comprise the actions of identifying a set of WLANs which are considered applicable and the action of obtaining a PLMN-ID of the PLMNs, as described above. In addition, the method of this embodiment may comprise further actions, which are optional. For example, in the last step it will likely be so that the wireless communication device will only connect to the WLAN given that some conditions are fulfilled and if the conditions are not fulfilled the wireless communication device may connect to some other WLAN. In addition, when finding more than one applicable WLAN, an optional action of selecting which WLAN to connect to may be included.

In one embodiment the RAN can control whether the wireless communication device 2, 4 shall consider PLMN of the RAN or not. The RAN can use this embodiment to only allow a subset of the wireless communication devices to use the WLAN network with the same PLMN as the 3GPP radio network. This may be done based on subscription where only wireless communication device with a subscription including WLAN access is allowed to use the WLANs. The RAN would then indicate to the wireless communication device whether or not the wireless communication device is allowed on the WLAN network or not. The indication may be signalled in the NAS (Non-access Stratum and/or AS (Access Stratum) layer, and be sent from any suitable RAN node, such as NodeB, RNC (Radio Network Controller), or eNodeB.

Network sharing allows multiple operators to share the same radio network (or parts thereof). The different operators will have different PLMN-IDs and the radio network will broadcast these different PLMN-IDs.

However the wireless communication device would in most cases only be a subscriber of one of these operators and in one embodiment the wireless communication device will only consider the PLMN of the operator which the wireless communication device is a subscriber of.

In another embodiment the wireless communication device will in the scenario when the radio network indicates multiple PLMN-IDs consider more than one of the indicated PLMNs, e.g. consider all the indicated PLMNs. This is useful for example if the operators which are sharing the 3GPP network are also sharing a WLAN network, or have an agreement that the WLAN network of one operator can be used by subscribers of another operator. Consider for example if Operator X and Operator Y share 3GPP radio network, then that radio network would indicate the PLMN of Operator X and Operator Y. If Operator X has a WLAN network which subscribers of Operator Y is allowed to use then, according to this embodiment, the wireless communication device of Operator Y would consider also the PLMN of Operator X.

It would also be possible that the network indicates to the wireless communication device whether all PLMNs associated with the radio network should be considered. This can be realized by a one-bit indicator sent from the network to the wireless communication device with broadcast signalling and/or dedicated signaling. Alternatively the network may indicate which (of the many) PLMNs associated with the radio network should be considered by the wireless communication device. If, for example, the 3GPP radio network is shared between three operators; Operator A, Operator B and Operator C, where Operator A and Operator B shares WLAN network, while Operator C has its own WLAN network. The radio network may then indicate to a wireless communication device of Operator A that it should consider the PLMN of Operator A and Operator B, while indicating a wireless communication device of Operator C that it should only consider the PLMN of Operator C.

Some 3GPP operators have agreements with a partner which has a WLAN network and the agreement allows the (all or some) subscribers of the operator to use the partners WLAN network. The partner may or may not be a WLAN only operator. In one embodiment the radio network is configured to signal a PLMN of a partner of the operator. The wireless communication device could then be configured to consider the PLMN of the partner. This does not exclude that the wireless communication device is also considering the PLMN of the operator itself. Consider an example where an Operator A with a 3GPP network has an agreement with a WLAN-Operator B allowing the subscribers of Operator A to use the WLANs belonging to Operator B. The 3GPP network of Operator A would then provide to the subscribers both the PLMN of Operator A and of Operator B.

If it is a WLAN only operator it may not be possible to use PLMN as an identifier. Instead an identifier such as Operator Friendly Name such as “Boingo”, NAI Realm such as “access.boingo.com”, Roaming Consortium such as 001bc50050 or 001bc500b5, or other identifier my be used.

In a roaming scenario a subscriber of one operator is using the network of another operator. E.g. a subscriber of Operator A is traveling to an area where Operator A does not have a 3GPP network, but the subscriber is allowed to use another operator's, Operator B, network.

Below we will describe a few embodiments for the case of roaming. To simplify the explanation we will use as an example that a subscriber of Operator A is roaming in the 3GPP network of Operator B. For this subscriber the Operator A is sometimes referred to as the home operator, while Operator B is referred to as the visited operator.

In FIG. 5 which is a schematic view, it is shown at the left hand side a first network owned by Operator A and at the right hand side a second network owned by Operator B. On the first network side there is depicted two wireless communication devices 2, two WLAN APs 10 (Operator A), and a home network 6 (Operator A) for the communication devices 2. On the second network side there is depicted two wireless communication devices 4, one WLAN AP 10 (Operator A), one WLAN AP 12 (Operator B) and a home network 8 for the communication devices 4. It can be seen how a wireless communication device 2 (i.e. a subscriber of Operator A) is roaming in the second network. In this scenario there is a WLAN belonging to Operator A in the service area of Operator B.

In the roaming scenario, it may be so that the roaming subscriber is only allowed to use the 3GPP network of Operator B but not the WLAN network of operator B. In one embodiment the wireless communication device 2 will when roaming not consider the PLMN of the radio in which it roams in. It may instead consider other PLMNs, e.g. PLMNs provided by the home operator.

It may also be so that the roaming wireless communication device 2 is allowed to use the WLAN network of the operator owning the 3GPP network in which the wireless communication device is roaming (i.e. Operator B in the above example). However the price for the subscriber to use Operator B's WLAN network may be higher than using another WLAN network. Like in the example in the figure above, it may be cheaper for the wireless communication device to use the first WLAN (belonging to Operator A) compared to using the second WLAN (belonging to Operator B). In one embodiment the wireless communication device will do a prioritization among the prioritized PLMNs based on some criteria. An example is that the wireless communication device is prioritizing the PLMN belonging to (or provided by) the home operator over a PLMN belonging to (or provided by) the visited operator. According to this embodiment the wireless communication device could, for example, if it finds one (or more) WLAN with the PLMN of the home operator and one (or more) WLANs with the PLMN of the visited operator prioritize the home operator. It should be noted that the wireless communication device may also apply some other criteria when selecting which of these WLANs should be used, e.g. if the WLAN with the home operator's PLMN has radio conditions below a certain threshold the wireless communication device may still connect to the WLAN with the visited operator's PLMN, even if this may result in a higher cost.

The network may indicate to the wireless communication device whether or not roaming wireless communication device should consider the PLMN of the radio network. The home operator and the visited operator may only have an agreement that subscribers should be allowed to use the 3GPP network but not the WLAN network, if so the network could indicate that the roaming wireless communication device should not consider the PLMN of the radio network. The wireless communication devices know whether they are roaming or not and hence if they should consider the PLMN or not.

With reference to FIG. 6, which is a schematic block diagram, a wireless communication device 2 will now be described in accordance with one exemplifying embodiment.

In this exemplifying the wireless communication device 2 is implemented as a UE. The wireless communication device 2 comprises a communication module 18, a controller 14, and optionally a SIM 16.

The wireless communication device 2 is adapted to connect to a RAN of a cellular communication network of any suitable radio access technology, such as LTE, UMTS, LTE Advanced or WiMax. The wireless communication device is further adapted to connect to access points of WLANs.

The controller 14 is adapted to identify a set of operators which are considered applicable to the wireless communication device for WLAN mobility. Each operator of the set of operators is associated to at least one corresponding WLAN. The controller 14 is further adapted to obtain an operator identity for each of the operators of the set of operators. Furthermore, the controller 14 is adapted to determine a set of applicable WLANs, such as WLANs provided by the operator or the partner of the operator, based on the obtained operator identities.

The communication module 18 is adapted to scan for available WLANs. Moreover, the controller 18 is further adapted to determine whether a WLAN found during the scanning is applicable for the wireless communication device 2, based on the operator identities of the set of operators. Finally, the communication module 18 is further adapted to connect to the found WLAN in response to that the found WLAN is determined applicable.

In an alternative embodiment which is based on the one described above, the operator identity is implemented as a PLMN-ID, i.e. an identity of a PLMN. In other alternative embodiments, the operator identities may be implemented as any of an operator friendly name, a NAI (Network Access Identifier) Realm, and a roaming consortium, etc.

However, as discussed above, the disclosed concept of some embodiments is not limited to UEs, and any suitable wireless communication device may be applied instead when appropriate. It should also be understood that the controller 14 and the communication device 18 are adapted to perform all of the steps of the method described above in conjunction with FIGS. 3 and 4.

The methods and arrangements according to the above described embodiment allows for provisioning of WLAN identifiers potentially without any additional radio interface signalling which is beneficial both from a radio resource efficiently point of view and power consumption point of view.

It is to be noted that the arrangements of the described exemplifying embodiments are described in a non-limiting manner. Typically, a designer may select to arrange further units and components to provide appropriate operation of the receivers, within the described concept, e.g. further processors or memories. Moreover, physical implementations of the proposed arrangements may be performed alternatively within the disclosed concept. For instance, functionality of a specific illustrated unit may be implemented in another suitable unit when put into practice.

Reference throughout the specification to “one embodiment” or “an embodiment” is used to mean that a particular feature, structure or characteristic described in connection with an embodiment is included in at least one embodiment. Thus, the appearance of the expressions “in one embodiment” or “in an embodiment” in various places throughout the specification are not necessarily referring to the same embodiment. Further, the particular features, structures or characteristics may be combined in any suitable manner in one or several embodiments. Although the present invention has been described above with reference to specific embodiments, it is not intended to be limited to the specific form set forth herein. Rather, the invention is limited only by the accompanying claims and other embodiments than the specific above are equally possible within the scope of the appended claims. Moreover, it should be appreciated that the terms “comprise/comprises” or “include/includes”, as used herein, do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

### Numbered Example Embodiments, NEE

The technology disclosed herein thus encompasses the following non-limiting example

### Embodiments

NEE 1. A method performed by a wireless communication device for controlling its access to one or several Wireless Local Area Networks (WLANs), wherein the wireless communication device is associated with a cellular communication network of an operator or a partner of said operator, the method comprising:
   identifying a set of operators which are considered applicable to the wireless communication device, wherein each operator of the set of operators is associated one or more corresponding WLANs,
   obtaining an operator identity for each of the operators of the set of operators,
   scanning for available WLANs,
   in response to finding WLAN during the scanning, determining whether a found WLAN is applicable for the wireless communication device, based on the operator identities of the set of operators,
   connecting to the found WLAN in response to that the found WLAN is determined applicable.
NEE 2. The method according to NEE 1, wherein the operator identity is implemented as one of a set comprising: PLMN-ID (Public Land Mobile Network Identity), an operator friendly name, a NAI (Network Access Identifier) Realm, and a roaming consortium.
NEE 3. The method according to NEE 1 or 2, further comprising determining whether a signal strength of the found WLAN is above a pre-defined threshold, and wherein connecting to the found WLAN is performed only in response to the signal strength being above the threshold.
NEE 4. The method according to NEE 1 to 3, wherein obtaining the operator identity comprises receiving the operator identity from a Radio Access Network (RAN) node of the cellular communication network.
NEE 5. The method according to NEE 1 to 3, wherein obtaining the operator identity comprises retrieving the operator identity from a Subscriber Identity Module (SIM) of the wireless communication device.
NEE 6. A wireless communication device adapted to control the the wireless communication device's access to Wireless Local Area Networks (WLANs), wherein the wireless communication device is associated with a cellular communication network of an operator or a partner of said operator, the wireless communication device comprising:
   a controller adapted to identify a set of operators which are considered applicable to the wireless communication device for WLAN mobility; wherein each operator of the set of operators is associated at least one corresponding WLAN;
further adapted to obtaining an operator identity for each of the operators of the set of operators; and
further adapted to determine a set of applicable WLANs, such as WLANs provided by the operator or the partner of the operator, based on the obtained operator identities; and
   a communication module adapted to scan for available WLANs,
   the controller being further adapted to determine whether a WLAN found during the scanning is applicable for the wireless communication device, based on the operator identities of the set of operators, and
   the communication module is further adapted to connect to the found WLAN in response to that the found WLAN is determined applicable.
NEE 7. The wireless communication device according to NEE 6, wherein the operator identities is implemented as one of a set comprising: PLMN-ID (Public Land Mobile Network Identity), an operator friendly name, a NAI (Network Access Identifier) Realm, and a roaming consortium.
NEE 8. The wireless communication device according to NEE 6 or 7, wherein the controller is further adapted to determine whether signal strength of the found WLAN is above a pre-defined threshold, and the communication module is further adapted to connect to the found WLAN only in response to the signal strength being above the threshold.
NEE 9. The wireless communication device according to NEE 6 to 8, wherein the communication module is adapted to receive the operator identity of each of the operators of the set of operators from a RAN node of the cellular communication network.
NEE 10. The wireless communication device according to NEE 6 to 8, further comprising a Subscriber Identity Module (SIM), wherein the controller is adapted to retrieve the operator identity of each of the operators from the SIM of the wireless communication device.

Modifications and other variants of the described embodiment(s) will come to mind to one skilled in the art having the benefit of the teachings presented in the foregoing descriptions and the associated drawings. Therefore, it is to be understood that the embodiment(s) is/are not to be limited to the specific examples disclosed and that modifications and other variants are intended to be included within the scope of this disclosure. Although specific terms may be employed herein, they are used in a generic and descriptive sense only and not for purposes of limitation.

1-10. (canceled)

11. A method performed by a wireless communication device for controlling its access to one or several Wireless Local Area Networks (WLANs), wherein the wireless communication device is associated with a cellular communication network of an operator or a partner of said operator, and the method comprises:
identifying a set of operators which are considered applicable to the wireless communication device, wherein each operator of the set of operators is associated with one or more corresponding WLANs;
obtaining an operator identity for each of the operators of the set of operators;
scanning for available WLANs;
in response to finding a WLAN during the scanning, determining whether a found WLAN is applicable for the wireless communication device, based on the operator identities of the set of operators;
connecting the wireless communication device to the found WLAN in response to determining that the found WLAN is applicable.

12. The method according to claim 11, wherein the operator identity is implemented as one of a set comprising: PLMN-ID (Public Land Mobile Network Identity), an operator friendly name, a NAI (Network Access Identifier) Realm, and a roaming consortium.

13. The method according to claim 11, further comprising determining whether a signal strength of the found WLAN is above a pre-defined threshold, and wherein connecting to the found WLAN is performed only in response to the signal strength being above the threshold.

14. The method according to claim 11, wherein obtaining the operator identity comprises receiving the operator identity from a Radio Access Network (RAN) node of the cellular communication network.

15. The method according to claim 11, wherein obtaining the operator identity comprises retrieving the operator identity from a Subscriber Identity Module (SIM) of the wireless communication device.

16. A wireless communication device adapted to control the access of the wireless communication device to Wireless Local Area Networks (WLANs), wherein the wireless communication device is associated with a cellular communication network of an operator or a partner of said operator, the wireless communication device comprising:
a controller adapted to:
identify a set of operators which are considered applicable to the wireless communication device for WLAN mobility; wherein each operator of the set of operators is associated with at least one corresponding WLAN;
obtain an operator identity for each of the operators of the set of operators; and
determine a set of applicable WLANs, such as WLANs provided by the operator or the partner of the operator, based on the obtained operator identities; and
a communication module adapted to scan for available WLANs;
wherein the controller being further adapted to determine whether a WLAN found during the scanning is applicable for the wireless communication device, based on the operator identities of the set of operators; and
wherein the communication module is further adapted to connect the wireless communication device to the found WLAN in response to the found WLAN being determined to be applicable.

17. The wireless communication device according to claim 16, wherein the operator identities is implemented as one of a set comprising: PLMN-ID (Public Land Mobile Network Identity), an operator friendly name, a NAI (Network Access Identifier) Realm, and a roaming consortium.

18. The wireless communication device according to claim 16, wherein the controller is further adapted to determine whether a signal strength of the found WLAN is above a pre-defined threshold, and the communication module is further adapted to connect to the found WLAN only in response to the signal strength being above the threshold.

19. The wireless communication device according to claim 16, wherein the communication module is adapted to receive the operator identity of each of the operators of the set of operators from a RAN node of the cellular communication network.

20. The wireless communication device according to claim 16, further comprising a Subscriber Identity Module (SIM), wherein the controller is adapted to retrieve the operator identity of each of the operators from the SIM of the wireless communication device.
